(19) United States
(12) Patent Application Publication
(10) Pub. No.: US 2025/0106455 A1
(43) Pub. Date: Mar. 27, 2025

(54) RECORDED VIDEO FEED AND STREAMING TRANSMISSION WITH DEFINITIVE IDENTITY VERIFICATION SYSTEM TO DETECT SYNTHETIC VIDEO AND PHOTOGRAPHIC IMAGES FOR COMMERCIAL AND CONSUMER CLIENTS

(71) Applicant: STEPHEN G. GIRAUD, CLEARWATER, FL (US)

(72) Inventor: STEPHEN G. GIRAUD, CLEARWATER, FL (US)

(21) Appl. No.: 18/047,288

(22) Filed: Oct. 18, 2022

Related U.S. Application Data
(60) Provisional application No. 63/257,120, filed on Oct. 19, 2021.

(51) Int. Cl. H04N 21/258; H04N 21/4415

(52) U.S. Cl. CPC H04N 21/25875; H04N 21/4415

(57) ABSTRACT

A recorded video feed and streaming transmission system is adapted for encrypting, gathering, identifying and authenticating biometric data of a specific human being, compared to government issued forms of identification, while constantly monitoring, tracking, analyzing, storing and distributing biometric data ensuring authorized access to the secured system continues by evaluating biometric data for participating computer systems and or programs. Multiple cooperative, correlative, inseparable, embedded serial numbers, unsolvable mathematical puzzles and QR codes, being “attached” from frame to frame, enable editing within a recorded audio/video session. The degree of identity verification correlated with the various serial numbers, unsolvable mathematical puzzles and QR codes, directly affects an indelible, superimposed identity verification cumulative authentication rating score in conjunction with a recognizable and standardized, indelible, superimposed hyperlinked, appropriately color-coded security badge displaying the degree of identity authentication for viewers. If any of the cooperative and correlative components is altered, the manipulated audio/video is detected.

### CLAIM OF PRIORITY

This application claims priority to and the benefit of U.S. Provisional application with Ser. No. 63/257,120, filed on Oct. 19, 2021, with the same title, the contents of which is incorporated herein by reference in its entirety.

### FIELD OF THE INVENTION

This invention relates a computer implemented system and method for the detection and prevention of synthetic video and photographic images using a recorded video feed and streaming transmission system for encrypting, gathering, identifying and authenticating biometric data of a specific human being, which is compared to government issued forms of identification, while constantly monitoring, tracking, analyzing, storing and distributing biometric data ensuring continuous authorized access to the secured system.

### BACKGROUND

Systems and methods for the detection, verification, and prevention of synthetic video and photographic images are known in the art prior art. One such example is US Published Patent Application 2020/0065526, titled “System And Methods For Detecting Modifications In A Video Clip” which is based on frame signatures embedded within a video clip wherein first pixels within a first image frame of the video clip representing an area of interest within the first image frame may be identified. The area of interest may correspond to a person's face or another object. A first frame signature may be calculated based on the first pixels, and second pixels within a second image frame of the video clip representing an area of interest within the second image frame may be identified. A second hash value may be calculated based on the second pixels. The authenticity of the video clip may be determined by comparing the first and second hash values against data extracted from third pixels within the first image frame that do not correspond to the area of interest in the first image frame.

Although recorded video feed and streaming transmission methods and systems are known, one vulnerability that persists in the industry is the lack of verified and verifiable authentication of the audio, video and photographic image recording with identity of a specific human being while accessing and participating in recorded video feed and streaming transmission systems. Known recorded video feed and streaming transmission methods and systems do not verify the authentication of a specifically identified human being via constant monitoring of recorded feed and streaming transmissions, dynamic biometric data nor do they verify said identities via appropriate governmental agencies having performed due diligence on proof of life identification. Also, once a specific individual user has been identified with the aid of biometric verification markers and has been granted access to a secure recorded video feed and streaming transmission system, constant monitoring of dynamic biometric data correlated with uniquely pertinent personal biographic information is required to ensure that an unauthorized individual has not gained access to the system, creating an opportunity for unauthorized individuals to access the secure recorded video feed and streaming transmission system and unauthorized manipulation and or unauthorized editing of the recorded media.

Although the recorded video feed and streaming transmission industry is aware of this, current methods for securely gathering, identifying, authenticating and registering uniquely specific individual user data are imprecise at best. There too, is a perception amongst users that their privacy is being violated by the collection of biometric data for verification purposes causing justifiable concern about potential vulnerability to identity theft.

There exists a need to incentivize users to register their biometric data while concurrently addressing the privacy concerns to maintain public anonymity by enabling users to operate under an alias and or avatar, in exchange for increased identity security, an open source architecture (OSArc), accurate rating systems with user feedback and offers of incentives such as commercial discounts, commercial coupons or frequent user rewards, contributing to and governing the systems terms of service and end user agreement utilizing self-sovereign identity principles. In addition, there is a lack of ubiquity in providing a registered individual user from using multiple registered or unregistered cameras and computer devices as they move throughout the mobile society.

Finally, there is a need for recorded video feed and streaming transmission systems to interface dynamically with specific markets, including but not limited to multiple types of identity fraud prevention, authentic marketing and research campaigns, e-commerce, workplace enforcement, government program and intelligence utilization, and regulatory/law enforcement, to name just a few. Thus, there exists a need for a recorded video feed and streaming transmission method and system for business to business (B2B), consumer to business (C2B) and or consumer to consumer (C2C) commercial market applications that securely gathers, identifies, authenticates and registers uniquely specific individual user biometric markers correlated with uniquely pertinent personal biographic information that constantly monitors, tracks, analyzes, stores and distributes encrypted dynamic individual user data of a specific human being to provide authenticated audio, video and photographic image recordings for consumer, research, commercial and government clients.

### SUMMARY OF THE INVENTION

The present invention overcomes the aforementioned problems and is distinguished over the prior art in general, by a recorded video feed and streaming transmission method and system to detect, through an app and website, authentic audio, video and photographic images utilizing individual identity verification, for personal, research, commercial, government and consumer clients with authentication based on definitive real-time identity verification of a specific human being using various registered Internet connected devices within wired or wireless computing communication devices connected to the Internet utilizing microphones, thumbprint scanners and speakers to interface between the systems servers and networked computer systems for securely gathering, identifying, authenticating and registering individual user biometric markers correlated with uniquely pertinent personal biographic information while monitoring, tracking, analyzing, storing and distributing authenticated individual user security badge data including encrypted indelibly embedded session serial numbers correlated with encrypted indelibly embedded sequential serial numbers or unsolvable mathematical puzzles and QR codes in addition to or in place of serial numbers to prevent quantum computing deciphering within the specifically identified individuals face, the audio file within each recorded frame and an indelible detectable identity verification cumulative authentication rating score for identity fraud detection, authentic marketing and research campaigns, e-commerce, workplace enforcement, government program and intelligence utilization, and regulatory/law enforcement markets.

Another significant difference and advantage of the present invention, as described hereinafter, is that synthetic manipulated video detection is based on an individual registering their multimodal biometric markers and compared to an authentically issued government form of identification to definitively verify the identity of a specific human being within recorded audio, video and photographic media and is based on the detection of synthetic audio, video and photographic recorded media.

Other differences and advantages of the invention will become apparent from time to time throughout the specification and claims as hereinafter related.

### Overview of the Present Invention

Techniques are provided herein for the scheduling and connection of recorded video feed and streaming transmissions between wired and or wireless computing communication devices such as mobile phones, tablets, smart watches, gaming devices and any other Web network, or PC connected to the Internet utilizing microphones, thumbprint scanners, speakers and various style web cameras as a “user device” (individual user-uploads/views media) to the systems servers consisting of a “Communication Manager” (CM) within the system for participating in a recorded video feed and streaming transmission. The individual user's (uploads/views media and talent community) computing communication device is required to verify their identity with the communication manager in order to authenticate, edit, store and distribute the recorded media. This paradigm is referred to herein as “real-time recorded video feed and streaming transmission.” The relevance of a recorded video feed and streaming transmission is pre-established by an individual user's (uploads/views media) computing communication device establishing a virtual relationship between an individual user's (uploads/views media) computing communication device and the communication manager, or by a deliberate act of an individual user's (uploads/views media) computing communication device being registered for recorded video feed and streaming transmissions.

The recorded video feed and streaming transmission is processed by the systems servers consisting of a “Communication Operations Center” (COC) to generate a recorded video feed and streaming transmission session that is appropriate and compatible with the communication manager that receives the recorded video feed and streaming transmission session. The systems communication operations center recognizes and notifies, in real-time, an individual users' (uploads/views media) computing communication device about the scheduled transmission session. If an individual user, operating a computing communication device, instructs his/her device to confirm the scheduled invitation for a transmission session, then the communication operations center receives the transmission from the individual users' computing communication device.

A recorded video feed and streaming transmission between wired and or wireless computing communication devices such as mobile phones, tablets, smart watches, gaming devices and any other Web network, or PC connected to the Internet utilizing microphones, speakers and various style web cameras refers to the sending of data that has been captured and processed. Thus, a recorded video feed and streaming transmission is associated with low latency, e.g., less than one second between the transmission of the data to receiving the recorded video feed and streaming transmission between wired and or wireless computing communication devices such as mobile phones, tablets, smart watches, gaming devices and any other Web network, or PC connected to the Internet utilizing microphones, thumbprint scanners, speakers and various style web cameras. Additionally, latency or delay may be caused by any intermediate devices, such as any servers that further process the data or network devices that forward the data through a network. Further, the nature of the network (e.g., 4G, 5G, WiFi, broadband, etc.) may introduce delays. In order to be considered a “recorded video feed and streaming transmission”, the recorded stream must be transmitted between wired and or wireless computing communication devices such as mobile phones, tablets, smart watches, gaming devices and any other Web network, or PC connected to the Internet utilizing microphones, thumbprint scanners, speakers and various style web cameras without exceeding a pre-defined latency threshold (e.g., 0.5 seconds between transmitting and receiving between wired and or wireless computing communication devices such as mobile phones, tablets, smart watches, gaming devices and any other Web network, or PC connected to the Internet utilizing microphones, thumbprint scanners, speakers and various style web cameras to the system servers. Mobile network connections to the systems communication operations center for computing communication devices will also have an impact on the “recorded” nature of an audio, video and photographic image stream by potentially introducing a delay making instantaneous consumption impossible at times.

Within the recorded video feed and streaming transmission system, the biometric verification and data management system supports nine functions; gathering, identifying, authenticating, registering, monitoring, tracking, analyzing, storing and distributing individual user biometric markers correlated with uniquely pertinent personal biographic information and geo-location coordinates of individual users. Each function engenders an estimated 1 Mb of data per individual user, which will in turn be transmitted along with the recorded video feed and streaming transmission with standard quality of 480 pixels which uses 12 MB per minute to a multitude of wired and or wireless computing communication devices such as mobile phones, tablets, smart watches, gaming devices and any other Web network, or PC connected to the Internet utilizing microphones, thumbprint scanners, speakers and various style web cameras and stored in a central repository or decentralized blockchain. In regions of the globe with the densest populations, the entire process must be robust enough to manage billions of hits per day to a database and or decentralized blockchain, requiring the average turnaround time of biometric verification to be measured in milliseconds. Some regions of the globe may present unique demographic challenges; for instance, when numerous municipalities are scattered in areas where the capabilities and functionality of communication and technology are limited.

As described hereinafter, the present invention manages these challenges via six specific recorded video feed and streaming transmission system characteristics.

First, uniqueness of the online biometric verification process is authenticated by collecting a sufficient amount of biometric markers, pertinent personal biographic information from each individual user (uploads/views media and talent community), analyzed and compared to a state or federal government issued individual users identification to determine authenticity with the individual users data on file to verify the collected biometric markers and pertinent personal biographic information of the individual user.

Second, the biometric markers are dynamically gathered directly from the individual user (uploads/views media and talent community) at the individual users' wired and or wireless computing communication devices such as mobile phones, tablets, smart watches, gaming devices and any other Web network, or PC connected to the Internet utilizing microphones, thumbprint scanners, speakers and various style web cameras to prevent spoofing and identity theft.

Third, distributed Data Bank's (DB's) are diffused with the gathered information for various individual users (uploads/views media and talent community) distributed to the furthest reaches of the database based on the individual user's biometric markers, pertinent personal biographic information and geo-location coordinates. Retaining the individual user's data in distributed DB's, lowers bandwidth demands, provides near instantaneous retrieval response times, and reinforces the ubiquity of the system for individual users when they travel to different areas of the globe.

Fourth, an identification verification process utilizing biometric markers as a retrieval key when it is essential to verify an individual user's (uploads/views media and talent community) identity has been authenticated.

Fifth, each biometric detection and collection device integrated with the individual users (uploads/views media and talent community) wired and or wireless computing communication device such as mobile phones, tablets, smart watches, gaming devices and any other Web network, or PC connected to the Internet utilizing microphones, thumbprint scanners, speakers and various style web cameras is provided within the system and designed to recognize when the systems connection is offnet, and to mirror system connectivity when the system is disconnected from the Internet so that the Communication Manager (CM) within the Communication Operations Center (COC) of the system can implement identical actions within the system regardless of whether the system is connected to the Internet or not. When the system is disconnected, the system retains the gathered biometric markers correlated with pertinent personal biographic information, geo-location coordinates and recorded video feed and streaming transmission session data in a secured database and or decentralized blockchain until the connection is restored. The biometric markers correlated with pertinent personal biographic information, geo-location coordinates and recorded video feed and streaming transmission session data can be stored in the DB's until the site is connected and the biometric markers correlated with pertinent personal biographic information, geo-location coordinates and recorded video feed and streaming transmission session data can be uploaded, or until the systems DB's are directed to a mirror site for a Session Verification Request (SVR) or dynamic monitoring, positive recorded feed of the individual users' recorded video feed and streaming transmission session.

Sixth, the secured DB's can also be used for local identity verification using stored individual user (uploads/views media and talent community) information that has been authenticated by the Communication Operations Center (COC) communicating directly or indirectly with a state or federal agency via, but not limited to, an encrypted PDF417 two-dimensional high-density stacked linear barcode, capable of encoding text, files and data bytes, or similar, such as Optical Character Recognition, Ultra Violet Lighting and Hologram detection that may contain biometric data and or pertinent personal biographic information that has demonstrated proof of life identification for the individual user.

There are challenges specific to each region of the globe for implementing such massive scale biometric verification and personal data management used within a recorded video feed and streaming transmission system, especially in locations that lack dependable communication capabilities. In order to design and execute such a recorded video feed and streaming transmission system utilizing biometric identification and personal data management in regions with large populations, the region must have the technological means to support and store tremendous amounts of biometric and demographic information. It is preferred that biometric markers be used to identify individual users (uploads/views media), even though 1 Mb of data per individual user is estimated to be used, because the use of biometric markers ensures that each individual user will receive a unique identification number (UIN) that can be matched only to that specific individual human being. This amount of estimated daily data use will result in the necessity for the storage and access capability of hundreds of terabytes of information. Because of the deficiencies of aforementioned traditional IT-based centralized solutions, the present invention preferably employs a system of distributed data banks.

Within the recorded video feed and streaming transmission system, the biometric identification and personal data management system servers comprise a Communication Operations Center (COC), which is responsible for two keystone functions: The Communication Manager (CM) and the Archive Manager (AM). The CM is responsible for receiving all Session Verification Requests (SVR) from individual users (uploads/views media and talent community) and directing them to a Data Group (DG) where the individual user's biometric markers and personal data are stored. Once the SVR has been processed and verified or rejected by the Data Group Manager (DGM), the CM will automatically return the response to the individual user awaiting verification. The DGM is the database controller and processing center. The AM is responsible for monitoring all DG's (and mirrors) for damage, data integrity, system usage, scheduling regular backups and initiate emergency backups as needed. The AM is also responsible for data backups to hard, secure off-site locations, including decentralized blockchain as well as any needed restorations. DG's are databases and decentralized blockchain where individual user biometric markers and personal data are stored, grouped by criteria such as geographical region or operational and administrative criteria such as user density (i.e. 1,000,000 users per DG or numerically by unique individual user (uploads/views media) identification numbers. DG's (and mirror sites) are location independent as long as all system components are networked using an ultra high-speed network. When a SVR is received from the CM, the DGM will access the Data Banks (DB) where the individual users' biometric markers and personal data are stored and evaluate the SVR to determine if the individual user submitting the SVR matches the individual user “human being” the biometric markers and personal data belongs to. Once the SVR has been verified or rejected the response is routed back to the CM for responding to the individual user. The DGM monitors the time used for each SVR and if, due to traffic density, response time begins to go above the maximum response time threshold, the DGM will automatically route SVRs to as many mirror sites as necessary to remain within the required response time. The DG mirror sites mirror DG's (complete with DGM's), which are used to maintain processing speed and response time during periods of high demand.

Additionally, the CM is responsible for constantly monitoring all recorded video feed and streaming transmission sessions of individual users (talent community) and directing them to a Data Group (DG) where the individual user's biometric markers, personal and session data are stored. Once the session begins processing and is verified by the Data Group Manager (DGM), the CM will automatically return the response to the individual user awaiting verification along with assigning and embedding a cooperative and correlative session serial number (SSN), a user security badge (USB), a cumulative user rating score (URS), a frame serial number (FRSN), a facial serial number (FASN), and an audio serial number (ASN) that are all interdependent of each other, while it transcribes and stores audio files, video and photographic image files. Unsolvable mathematical puzzles and QR codes may be used in place of or in addition to serial numbers. The DGM then processes these functions as described above.

### BRIEF DESCRIPTION OF THE DRAWINGS

FIG. 1 is a block diagram that depicts the system architecture of an exemplary embodiment of the present system.

FIGS. 2A and 2B taken together is a flow chart illustrating the steps of an exemplary embodiment of a method of the present invention when utilized for applying and registering for access to an identity verification system for authenticating biometric markers of a specific human being correlated with pertinent personal biographic information and geo-location coordinates granting authorized access to recorded video feed and streaming transmissions of video and photographic images;

FIG. 3 is a simplified block diagram of an exemplary embodiment of a registered OEM biometric detection and collection device interfacing with an individual users' (uploads/views media and talent community) wired and or wireless computing communication devices such as mobile phone, tablet, smart watch, gaming device and any other Web network, or PC connected to the Internet utilizing microphones, thumbprint scanners, speakers and various style web cameras;

FIG. 4 is a simplified block diagram of an exemplary embodiment of the present invention of a biometric verification and individual user data management system for the initial registration and verification of a session, illustrating the functional steps of a method of verifying biometric markers correlated with the prospective individual user (uploads/views media and talent community) data of a specific human being;

FIG. 5 is a simplified block diagram of phase two of FIG. 4, illustrating an exemplary embodiment of the present invention of the biometric verification and individual user data management system for constantly monitoring recorded video feed and streaming transmission of audio, video and photographic image sessions, illustrating the functional steps of a method of monitoring within a predetermined amount of time, tracking, analyzing, storing and distributing individual user security badge data and recorded biometric markers correlated with individual user (uploads/views media and talent community) data of a specific human being.

FIG. 6 is a simplified block diagram of phase three of FIG. 4, illustrating an exemplary embodiment of the present invention as a registered or unregistered computer device transmits a recorded audio, video and or photographic image of a specific human being, the data management system assigns and embeds indelible, detectible, hyperlinked, appropriately color-coded identity verification security badge data including date/time along with an indelible, detectable identity verification cumulative authentication rating score, encrypted, indelible, undetectable serial numbers and or unsolvable mathematical puzzles and QR codes in a predetermined audio, video and or photographic image frame, indicating an authentically recorded audio, video and or photographic image through the system.

FIG. 7 is a flow chart illustrating the steps of an exemplary embodiment of the distribution method of the present invention when initiated by an individual user (uploads/views media) to be utilized by a particular subscriber client with the requirements of each subscriber client being unique and the present invention configured to accommodate the differing requirements of each subscriber client's distribution channels.

FIG. 8 is a flow chart illustrating the steps of an alternate embodiment of the distribution method of the present invention when initiated by an individual user (uploads/views media) acting as a subscriber clients representative to be utilized for a particular subscriber client with each of their requirements being unique and the embodiment of the present invention configured to accommodate the differing requirements of each subscriber client's distribution channels.

FIG. 9 is a bi-directional sequence diagram that depicts a sequence of steps that are performed by different elements within the systems of FIG. 1 through FIG. 8.

### DETAILED DESCRIPTION OF THE INVENTION

Definition of Terms. In conjunction with the present invention, the following terms have the following meanings.

Business models—The term “B2B” means Business to Business. A “B2B” type of business model is suitable for companies that facilitate the transaction of products and or services to another company, which in this example is the final client who then utilizes the product and or service. The term “B2C” means Business to Consumer. A “B2C” type of business model is suitable for companies that facilitate the transaction of products and or services to a consumer, which in this example is the final client who then utilizes the product and or service. The term “C2C” means Consumer to Consumer. A “C2C” type of business model facilitates the transaction of products and or services between consumers and gives an opportunity to sell or purchase goods and or services directly with each consumer as a potential final client.

Subscriber clients-Subscriber clients consist of any registered final research, commercial and or government client and their representatives who facilitate the transaction of and utilizes the product and or service as described within the system.

Users-Users consist of one or more of two categories, both of which facilitate the transaction of, and utilizes the product and or service as described within the system: (1) registered individuals that upload and or view media on video hosting platforms and (2) registered individuals within the talent community which may be composed of actors, models, posers and or a cast of characters.

Sessions—A session is created by scheduling a recorded video feed and streaming transmission within the system of invention. A new session may be created on the scheduling request by a user (uploads/views media) to the Communication Operations Center (COC). A session is a state of elapsed time that is preserved between both individual user and the Communication Operations Center within a scheduled request initiated by an individual user and accepted by the Communication Operations Center. A session must be authorized by both an individual user and the Communication Operations Center to enable access to a recorded video feed and streaming transmission within the system of invention for processing.

Within a session, any contents of a recorded video feed and streaming transmission may be recorded outside of the systems individual user and the Communication Operations Center. The request to initiate a recorded video feed and streaming transmission from an individual user and device may be used to schedule many sessions from an individual user to the Communication Operations Center simultaneously for processing.

Sessions are stored in the systems distributed Data Banks (DB's), an external data base or decentralized blockchain. A subscriber client that requests stored sessions may contact the system of invention, which performs a local fetch from a queue or performs a remote fetch by sending a request to either an external data base or decentralized blockchain. An Advanced Message Queuing Protocol (AMQP) server may be used as a common bus for session distribution: an object change event is broadcasted to all data bases or decentralized blockchain instances, consumed by the appropriate recorded video feed and streaming transmissions processed, and distributed to session queues.

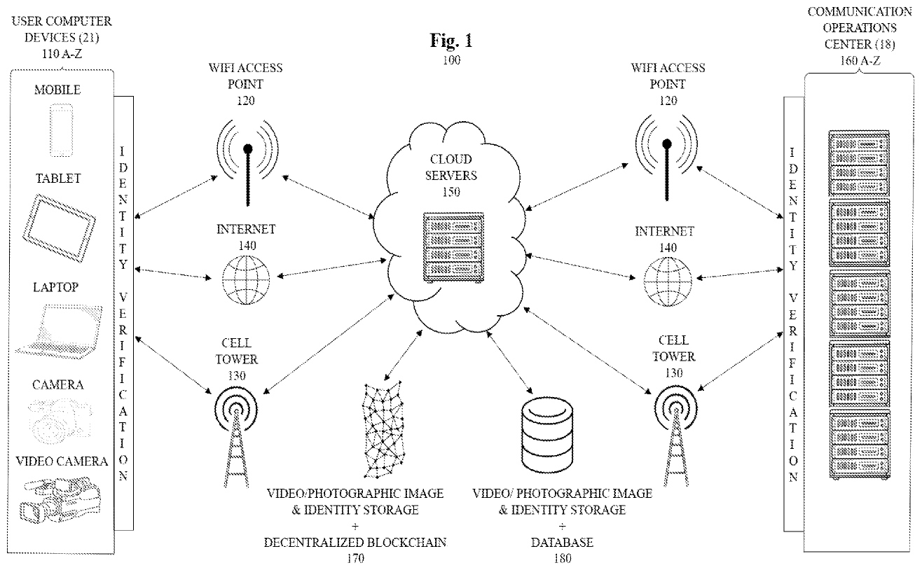

Referring now to the drawings by numerals of reference, FIG. 1 depicts an example system architecture 100, according to an embodiment of the invention. System architecture 100 comprises individual user (uploads/views media and talent community) computer devices 110A-Z utilizing identity verification, a Wi-Fi access point 120, a cell tower 130, the Internet 140, Cloud Server 150, Communication Operations Center (18) 160A-Z utilizing identity verification, with decentralized blockchain 170 and a database 180 for storing individual user identity and recorded video feed and streaming transmission data.

The Communication Operations Center (18) 160A-Z utilizing identity verification may execute software that enables individual user computer devices 110A-Z utilizing identity verification to transmit real-time recorded stream notifications to Cloud Server 150 and receive a recorded video feed and streaming transmission, in real-time, from another intermediary associated with Cloud Server 150. System architecture 100, particularly Cloud Server 150, allows for different types of recorded media uploading: registered tablet-to-communication operations center, laptop-to-communication operations center, camera-to-communication operations center and video camera-to-communication operations center.

The individual user that operates computer device 110A-Z utilizing registered identity verification is referred to herein as the “user”. As indicated above, computer device 110A-Z utilizing identity verification may be referred to as a “user computer device.” User computer device 110A-Z utilizing identity verification captures stored images and transmits a recorded video feed and streaming transmission from the stored captured images. User computer device 110A-Z utilizing identity verification executes a software application that establishes a communication channel with Cloud Server 150 in order to send the recorded video feed and streaming transmission (and an indication thereof) to Cloud Server 150. The application causes metadata about the recorded video feed and streaming transmission e.g., information about the user of user computer device 110A-Z, utilizing identity verification information about user computer device 110A-Z utilizing identity verification and a title for the recorded video feed and streaming transmission session data of user computer device 110A-Z utilizing identity verification, to be sent along with the recorded video feed and streaming transmission. Non-limiting examples of user computer devices 110A-Z utilizing identity verification include a wired and or wireless computing communication device such as mobile phones, tablets, smart watches, gaming devices and any other Web network, or PC connected to the Internet utilizing microphones, thumbprint scanners, speakers and various style web cameras that includes a video and or audio recorder.

Audio, video and photographic image streams from user computer devices 110A-Z utilizing identity verification are assigned and embedded a cooperative and correlative session serial number (SSN), a user security badge (USB), a cumulative user rating score (URS), a frame serial number (FRSN), a facial serial number (FASN), and an audio serial number (ASN) that are all interdependent of each other, then processed, stored, transcoded, transcribed and prepared for viewing consumption of recordings by software and hardware components (not shown) associated through Cloud Server 150 by Communication Operations Center (18) 160A-Z. Unsolvable mathematical puzzles and QR codes may be used in place of or in addition to serial numbers. Metadata about a recorded video feed and streaming transmission from user computer devices 110A-Z utilizing identity verification is also processed and stored in a DB. Metadata about a recorded video feed and streaming transmission session may be updated continuously within a personal profile page of users, such as the duration of a recorded video feed and streaming transmission session, the loss of a connection, reconnection, for users of a registered computer device, or the monetary incrementing from the users computer device that is contained within an e-wallet.

User Computer device 110A-Z utilizing identity verification is communicatively coupled to Cloud Server 150 via an optional Wi-Fi access point 120 or cell tower 130 and Internet 140. Similarly, Communication Operations Center (18) 160A-Z utilizing identity verification are communicatively coupled to Cloud Server 150 via an optional Wi-Fi access point 120 or cell tower 130 and Internet 140.

Cloud Server 150 receives an indication of a recorded video feed and streaming transmission that is being transmitted (or pending transmission) from User Computer device 110A-Z utilizing identity verification. Cloud Server 150 sends real-time recorded stream notifications of the recorded video feed and streaming transmission to Communication Operations Center (18) 160A-Z utilizing identity verification, whose users have previously subscribed for the notification. Components of Cloud Server 150 analyze changes in database tables and stores those changes for fast retrieval within a decentralized blockchain 170 and or a database 180.

As indicated above, the Communication Operations Center (18) 160A-Z utilizing identity verification may be referred to as “COC”. Any communication protocol that is necessary to transmit the recorded video feed and streaming transmission from Cloud Server 150 to the Communication Operations Center (18) 160A-Z utilizing identity verification may be used.

The Communication Operations Center (18) 160A-Z utilizing identity verification are any servers that are configured to receive a real-time notification of recorded video feed and streaming transmission from Cloud Server 150. As depicted in FIG. 1, non-limiting examples of the.

Communication Operations Center (18) 160A-Z utilizing identity verification include File Servers, Network Servers e.g. Local Area Network, Wide Area Network (WAN) each executing software that enables the server to receive real-time notifications from Cloud Server 150. Additionally, or alternatively, the Communication Operations Center (18) 160A-Z utilizing identity verification may transmit an email or SMS message that notifies the User Computer devices 110A-Z utilizing identity verification that a recorded video feed and streaming transmission is ready to receive. The users then have to use a web browser application or app software that enables the users to initiate the recorded video feed and streaming transmission from their respective devices.

If a User Computer device 110A-Z is a PC, such as a laptop or desktop computer, then the recorded video feed and streaming transmission may be transcoded to a Flash format (e.g., Flash file formats FLV or F4V) and then delivered to the Communication Operations Center (18) 160A-Z. If a User Computer device 110A-Z is a mobile device, then the recorded video feed and streaming transmission may be transcoded into a format that is supported by the mobile device and then transmitted to the Communication Operations Center (18) 160A-Z.

A real-time notification of a recorded video feed and streaming transmission may be sent to the Communication Operations Center (18) 160A-Z utilizing identity verification prior to any portion of the recorded video feed and streaming transmission being sent to Communication Operations Center (18) 160A-Z utilizing identity verification. Alternatively, the recorded video feed and streaming transmission and the real-time notification are sent contemporaneously to Communication Operations Center (18) 160A-Z utilizing identity verification. In this case, the Communication Operations Center (18) 160A-Z utilizing identity verification may display the real-time notification and at least a portion of the recorded video feed and streaming transmission simultaneously. The real-time notification provides an opportunity for the Communication Operations Center (18) 160A-Z to immediately receive or reject the recorded video feed and streaming transmission.

A real-time notification may indicate any type of information about the user and or the recorded video feed and streaming transmission. For example, a real-time notification may indicate the legal name or alias of the user of the registered User Computer device, and or any data indicated by the registered User Computer device, such as a level of priority of the recorded video feed and streaming transmission or session title given to the recorded video feed and streaming transmission session. Additionally, a real-time notification may include a frame of video from the recorded video feed and streaming transmission displaying the user or any selected avatar to protect privacy. Additionally, or alternatively, the recorded video feed and streaming transmission may be automatically distributed or posted to one or more video or photographic image hosting platforms without any input received from the one or more video or photographic image hosting platforms with or without prior editing. A potential video or photographic image hosting platform connects to Cloud Server 150 and specifies video or photographic image frames that are of interest to the viewer of the video or photographic image hosting platform. For example, a potential viewer may provide commercial data that indicates an area of interest in all future recorded video feed and streaming transmission sessions initiated by a potential user, recorded video feed and streaming transmissions whose corresponding title and or description includes a particular subject or priority, recorded video feed and streaming transmissions that are associated with a particular industry, recorded video feed and streaming transmissions that are produced in certain geo-locations or regions, and or recorded video feed and streaming transmissions that are produced during a particular and or available time period. Commercial data is stored in a database 180 and or decentralized blockchain 170.

The Communication Operations Center (18) 160A-Z utilizing identity verification might execute an application (e.g., a web browser application) that is communicatively coupled to a particular hosting application. The hosting application may be part of, for example, a research, commercial or government website or app. Thus, for example, if a registered User's Computer device is currently logged into a research, commercial or government website or app, then Cloud Server 150 sends a real-time notification to the research, commercial or government website or app using the appropriate identity of the registered users and the registered Users Computer device. The research, commercial or government website or app then uses the research, commercial or government website or app identity of the registered user to send the real-time notification to the viewers device, video or photographic image hosting platforms.

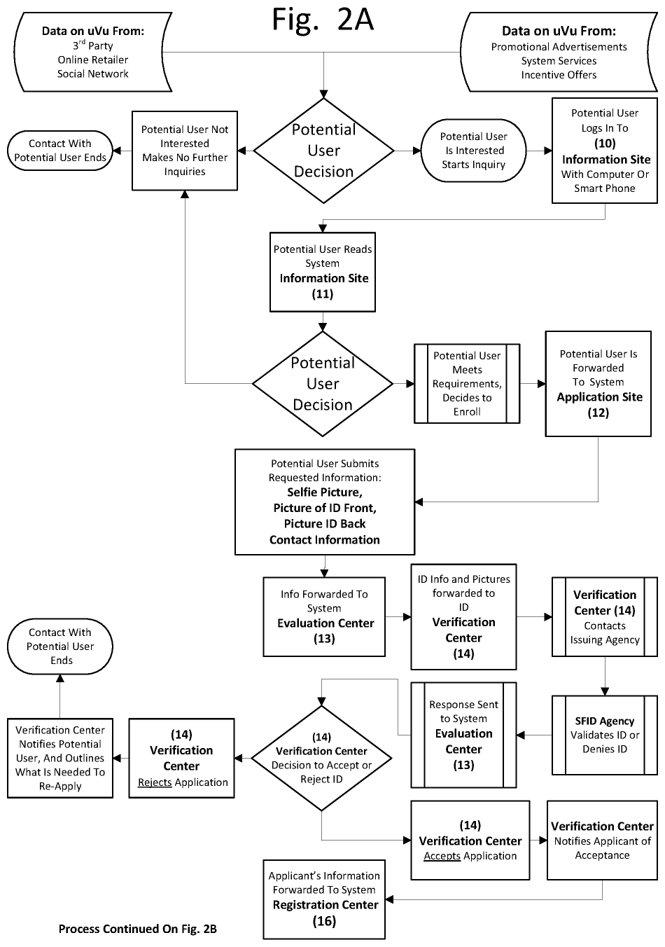

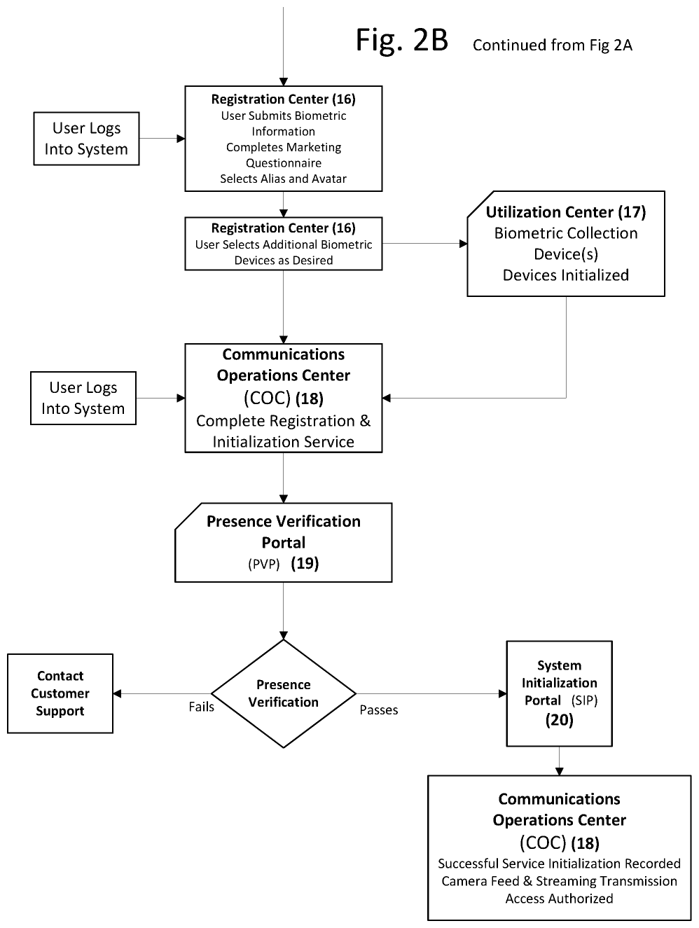

FIGS. 2A and 2B illustrate the steps of an exemplary embodiment of a method of the present invention when utilized for applying and registering for access to an online identity verification system for authenticating biometric markers of a specific human being correlated with pertinent personal biographic information and geo-location coordinates. A prospective individual user (uploads/views media and talent community) is guided from the systems website and or app of invention incentive programs and or through third party promotion via a wired and or wireless computing communication device such as mobile phones, tablets, smart watches, gaming devices and any other Web network, or PC connected to the Internet utilizing microphones, thumbprint scanners, speakers and various style web cameras that includes a video and or audio recorder 10. The prospective individual user enters the information section of the website and or app of the system 11, is educated and incentivized as to the services and benefits of the system's use and on the registration requirements which requires a current state or federally issued form of Identification (SFID) such as a driver's license, military, state identification, or passport. In the event that the applying individual user does not meet the requirements for registration, the applying individual user exits the system of invention and will have the opportunity to re-apply. In the event that the applying individual user does meet the requirements for registration, the applying individual user is guided into the application site of the systems website and or app 12 whereby the applying individual user is instructed to complete an online application and an associated questionnaire. The applying individual user is instructed to take a digital photograph of the applying individual user's current state or federally issued identification. The applying individual user displays his or hers identification within the cameras field of vision or scanning window as displayed on the applying individual users' computer or mobile computing communications device screen or by uploading the photograph from a separate registered or unregistered camera device within the field of vision or scanning window as displayed on the applying individual users' computer or mobile computing communications device screen. The next step in the application process is for the applying individual user to take his or her own digital photograph and verify “liveness” based on blinking, facial or head movement via a video selfie. The applying individual user is instructed to format his or her face within the provided displayed field of vision or scanning window of the registered or unregistered camera as produced on the applying individual users' computer or mobile computing communications device screen and once the registered or unregistered camera is in focus, blink the eyelids or move the face or head of the applying individual user, capture the image, save, then upload the video selfie of themselves and of the SFID along with the application to the application center within the system of invention. Once the application and the video selfie and or photographs of the applying individual user and of the state or federally issued identification are received within the evaluation center 13, the video selfie and or photographs are compared to one another in order to verify that the applying individual user matches the individual user displayed in the SFID through the analysis of biometric markers and complex biometric algorithms within the identification verification center 14. In the event that the authenticity of the applying individual user's SFID is rejected, then the applying individual user does not meet the requirements for registration within the evaluation center 13, the applying individual user will then exit the system of invention and will have the opportunity to re-apply. In the event that the applying individual user's video selfie and or photograph of themselves and of the SFID has been positively verified as identical by the identification verification center 14, the applying individual user's identification will be compared by, but not limited to a PDF 417 two-dimensional high-density stacked linear barcode, capable of encoding text, files and data bytes, or similar, such as Optical Character Recognition (OCR), Ultra Violet Lighting (UVL) and Hologram detection that may contain biometric data and pertinent personal biographic information that is often included on a current and corresponding government issued state or federal identification (SFID) 15 for electronic authentication. In the event that the applying individual user's state or federally issued identification is rejected by the SFID issuing agency 15 as being invalid, then the applying individual user does not meet the requirements for the evaluation center 13, the applying individual user is notified of the rejection and is instructed to correct the invalid identification before re-applying. In the event that the applying individual user's identification is authenticated through the SFID issuing agency 15, the applying individual user is notified of the SFID authentication then proceeds to the registration center 16.

At this step in the process, the applying individual user is instructed to fill out and to submit pertinent personal biographic information, a marketing questionnaire for interest and preferences, select an alias and an avatar for public identification display if desired. In addition, the applying individual user is instructed to select any additional biometric detection and collection device(s) 22 as needed for future use within the system of invention as desired. The initialization of the biometric detection and collection device(s) 22 is made by the utilization center 17. Within the utilization center 17, biometric detection and collection devices 22, key codes for downloading the biometric telemetry software, instructions for installing the biometric detection and collection device(s) 22 and software along with customer support A and contact information are provided if needed. The instructions direct applying individual users to log into the COC 18 to complete the final verification and initialization of service upon successful utilization of all biometric detection and collection device(s) 22 with corresponding software if needed. The applying individual user is then instructed to log into the system's COC 18 to complete the registration process in order to initiate service.

The next step in the registration process is for the registering individual user to enter the presence verification portal (PVP) 19 where the system performs a presence and “liveness” verification based on facial recognition, blinking, facial or head movement via a video selfie, voice and thumb print analysis or any other biometric marker in order to verify that the registering individual user is identical to the applying individual user. In the event that the presence verification fails, the registering individual user does not meet the requirements for the presence verification portal registration, the registering individual user contacts customer support and has the opportunity to re-register. In the event that the registering individual user passes the presence verification portal, the registering individual user is guided into the system initialization portal (SIP) 20 where additional biometric markers correlated with pertinent personal data and geo-location coordinates via biometric detection and collection device(s) may be gathered and processed. The SIP 20 then issues a unique identification number (UIN) to the registering individual user to be used within the recorded video feed and streaming transmission system of invention. Upon issuance of the UIN, the registered individual user has achieved a successful service initialization and is now authorized for recorded video feed and streaming transmissions, recordings and full public system access.

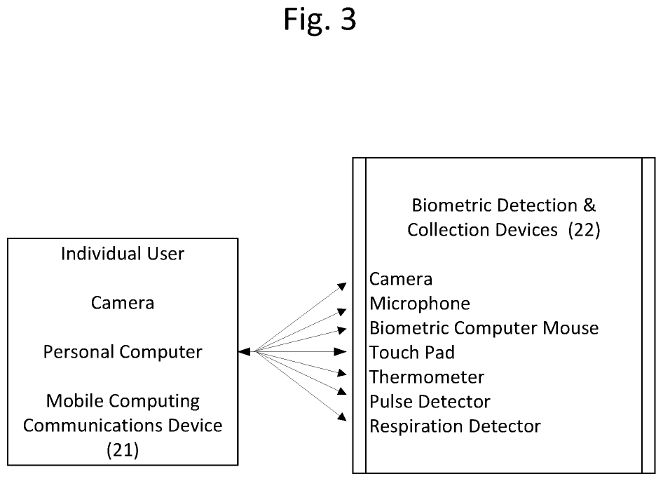

FIG. 3 is a simplified block diagram of an exemplary embodiment of an OEM biometric detection and collection device interfacing with wired and or wireless computing communication devices such as mobile phones, tablets, smart watches, gaming devices and any other Web network, or PC connected to the Internet utilizing microphones, thumbprint scanners, speakers and various style web cameras of an individual user (uploads/views media and talent community). As shown in FIG. 2B, the biometric collection device(s) utilization center 17, directs the individual user to initialize the biometric detection and collection device 22, along with corresponding biometric telemetry software on the individual users' computer or on a mobile computing communicating device 21. Upon successful initialization of the OEM biometric detection and collection device(s) and corresponding software, the individual user initializes the interface to test for connectivity and for successful communication. Upon verified communication between the individual user and the system, the individual user can log into the system.

The individual user initiates a session login on a computer or a mobile computing communicating device 21 whereby their biometric markers correlated with pertinent personal biographic information and geo-location coordinates are directed toward the COC 18 as shown in FIG. 2B. Once received by either the CM or the AM, the information is either directed toward the DG whereby the DGM directs the individual user's data to a DB or the AM directs it to a central repository and or decentralized blockchain.

Upon successful application and registration, the individual user logs into the system and upon successful login has full public access and use of the system. Commercial distribution is achieved by subscriber clients accessing the COC 18 as shown in FIG. 2B and selecting any number of products and or services detailed in the above embodiment. The AM is responsible for monitoring all DG's (and mirrors) for damage, data integrity, usage, scheduling regular backups and also initiates emergency backups as needed. The AM also is responsible for data backups to hard, secure off-site locations, as well as any needed restorations.

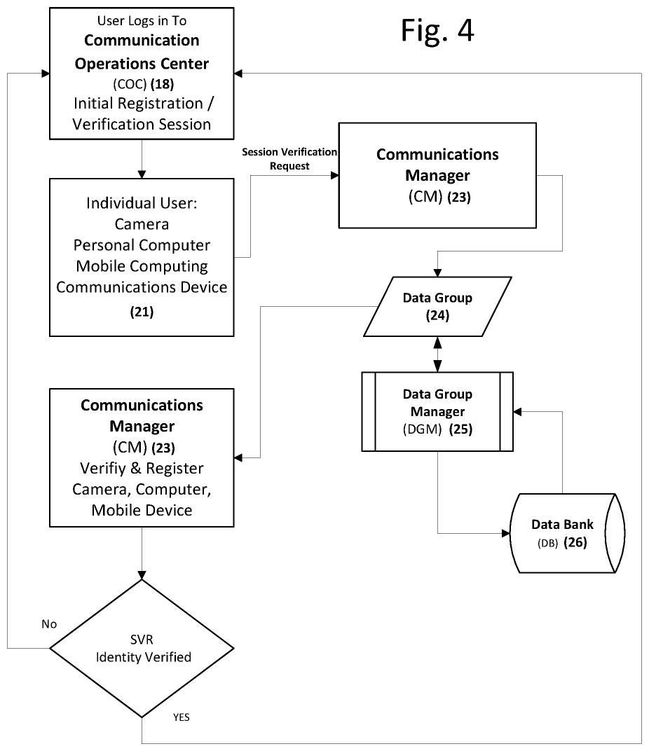

FIG. 4 is a simplified block diagram of a biometric verification and data management system for the initial identity verification of a session in an exemplary embodiment of the present invention illustrating the functional steps of a method of verifying biometric markers correlated with unique individual user (uploads/views media and talent community) data of a specific human being.

Phase one comprises the steps for the initial session identity verification of an individual user. The step begins with the individual user's wired and or wireless computing communication device such as mobile phones, tablets, smart watches, gaming devices and any other Web network, or PC connected to the Internet utilizing microphones, thumbprint scanners, speakers and various style web cameras 21 as shown in FIG. 3 transmitting a session verification request (SVR) which includes biometric markers of the individual user, pertinent personal biographic information, time, geolocation coordinates and the network/IP data of the individual user's wired and or wireless computing communication devices such as mobile phones, tablets, smart watches, gaming devices and any other Web network, or PC connected to the Internet utilizing microphones, thumbprint scanners, speakers and various style web cameras 21 as shown in FIG. 3.

Upon receipt of the transmitted SVR and individual user's data, the CM 23 within the COC 18 as shown in FIGS. 2A and 2B, will determine in which DG 24 the individual users' information is stored; and re-directs the SVR to the relevant DG 24. Upon receipt of the SVR and the accompanying individual user data, the DGM 25 compares the transmitted biometric markers, pertinent personal biographic information and geo-location coordinates with verified biometric markers, pertinent personal biographic information and geo-location coordinates on file at the DB 26. In addition, the DGM 25 compares the geo-location coordinates and time with the last session to determine whether the individual user could reasonably travel from the geo-location coordinates of the last session to the geo-location coordinates of the present session.

Upon the individual user's successful login for session use, the user's biometric markers correlated with unique pertinent personal biographic information and geo-location coordinates are directed toward the CM 23 within the COC 18 as shown in FIG. 2A2B. The CM 23 is responsible for receiving all SVR at user login and directing them to the DG 24 where the individual user's data is stored. Once the SVR has been processed and is either verified or unverified by the DGM 25, the CM 23 automatically returns the response to the individual user 21 waiting for verification.

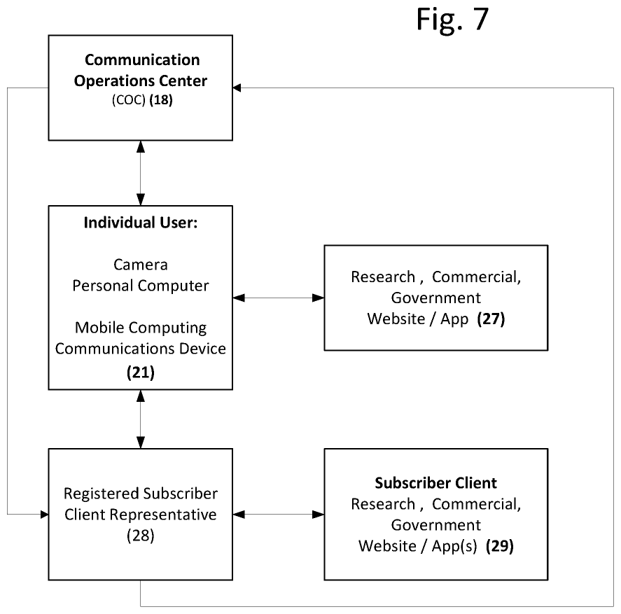

In the event the individual users' biometric markers, pertinent personal biographic information and geo-location coordinates match what is on file, the SVR is authenticated then said authentication is transmitted to the CM 23 of the COC 18 as shown in FIG. 2. The CM 23 directs the SVR authentication to the individual user 21 and or the subscriber client representative 28 as shown in FIG. 7, as appropriate. Once authentication to the individual user 21 and or the subscriber client representative 28 as shown in FIG. 7 is received, they have limited system access e.g. personal profile page and recorded video feed and streaming transmission sessions.

Upon the individual user's 21 successful login for recorded video feed and streaming transmission session use, along with the individual user's biometric markers correlated with unique pertinent personal biographic information and geo-location coordinates being directed toward the CM 23 within the COC 18 as shown in FIG. 2B, the individual user may verify and register a camera, personal computer and or mobile computing communications device (21) as shown in FIG. 3 utilizing one or more biometric detection and collection devices 22 as shown in FIG. 3.

In the event the individual users' registered camera, personal computer and or mobile computing communications device 21 as shown in FIG. 3 utilizing one or more biometric detection and collection devices 22 as shown in FIG. 3 is successfully verified and registered and then correlated to the individual users verified identity, the SVR is authenticated then said authentication is transmitted to the CM 23 of the COC 18 as shown in FIG. 2B. The CM 23 directs the SVR authentication to the registered individual user 21 and their registered device as approved. Once authentication of the individual user 21 along with their registered device 21 is received and approved, they may proceed with the recorded video feed and streaming transmission session.

The CM 23 is responsible for receiving all SVR at user login and directing them to the DG 24 where the individual user's data is stored. Once the SVR has been processed and is either verified or unverified by the DGM 25, the CM 23 automatically returns the response to the individual user 21 waiting for verification.

In the event the individual users' biometric markers, pertinent personal biographic information, geo-location coordinates, camera, personal computer and or mobile computing communications device utilizing one or more biometric detection and collection devices do not match what is on file, which may indicate fraud, (e.g. insufficient time for individual users (uploads/views media) to travel from the geo-location coordinates of the previous session to the geo-location coordinates of the present session or an unregistered individual), the SVR is unverified. The unverified SVR is transmitted to the CM within the COC, which then detects the unverified individual user and or subscriber client along with the corresponding recorded video feed and streaming transmission session.

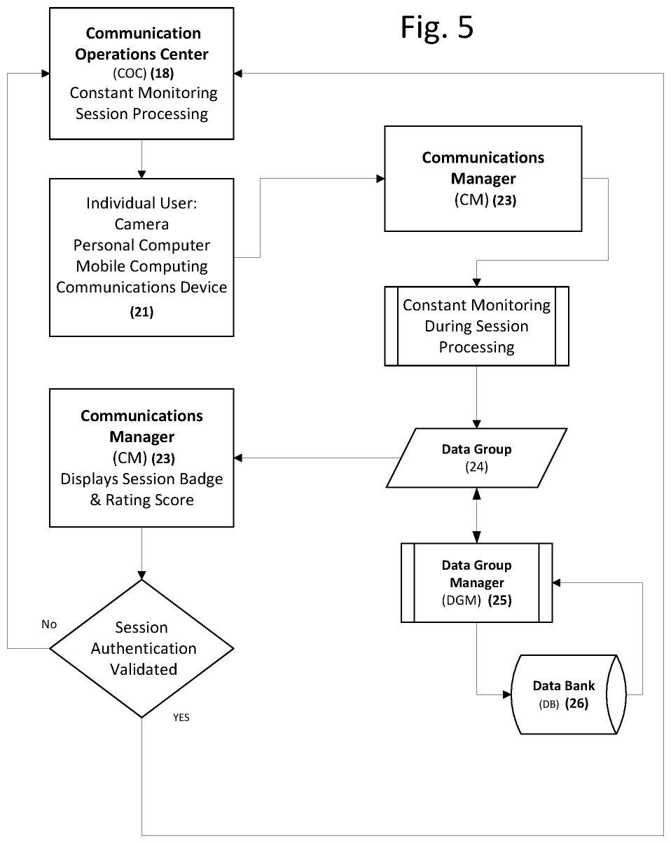

FIG. 5 shows phase two of FIG. 4, illustrating the functional steps of a method of constantly monitoring communication and recorded media processing within a predetermined amount of time, tracking, analyzing, storing and distributing recorded video feed and streaming transmission session data of a specifically identified human being.

Phase two, consists of constant monitoring of the recorded video feed and streaming transmission session to ensure the individual user (talent community) 21 is engaged in the system throughout the session processing. This consists of monitoring dynamic biometric markers to include but not limited to physiological and behavioral biometrics, facial, head or eyelid movement, pupillary dilation, or voiceprint, to maintain proof of life identification of the individual user during session processing. The CM 23 of the COC 18 as shown in FIG. 2B directs the constant monitoring stream recording to the relevant DG 24.

The DGM 25 subjects individual users (talent community) 21 to constant monitoring of biometric markers to comparisons during recorded video feed and streaming transmission processing with the individual users' biometric markers on file. In the event monitored biometric markers continue to match and is maintained, the recorded video feed and streaming transmission session is determined to be a valid authentication and embeds then superimposes a recognizable and standardized, indelible, detectible, hyperlinked appropriately color-coded security badge and an indelible, detectable identity verification cumulative authentication rating score between 0%-100% validating individual user authentication for viewer notification. In the event the individual user's monitored biometric markers are absent for a predetermined period of time or if the constantly monitored biometric markers change from that of the individual user during session processing, it is determined to be an invalid authentication and transmitted to the COC 18 as shown in FIG. 2B. The information that the individual users' biometric markers data stream is compromised, upon receipt, from the DGM 25; the COC 18 as shown in FIG. 2B embeds then superimposes a recognizable and standardized, indelible, detectible, hyperlinked appropriately color-coded security badge and an indelible, detectable identity verification cumulative authentication rating score between 0%-100% invalidating individual user authentication throughout the processing of the recorded video feed and streaming transmission session for viewer notification.

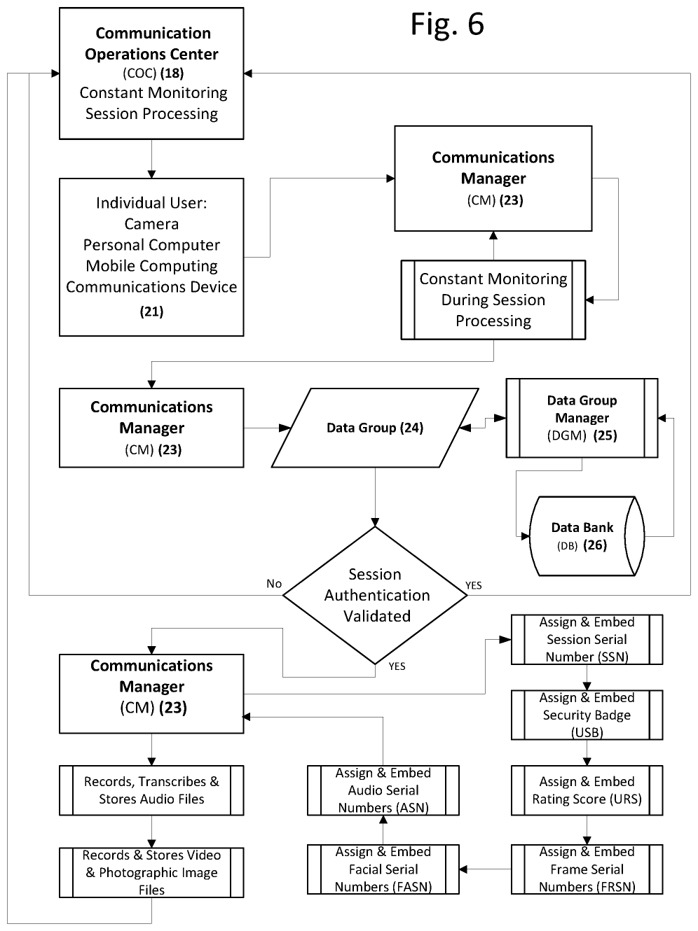

FIG. 6 is phase three of FIG. 4, illustrating the functional steps of a method of constantly monitoring recorded media and communication within a predetermined amount of time, tracking, analyzing, storing and distributing recorded video feed and streaming transmission session data of a specifically identified human being as it is being processed, followed by a method of assigning and embedding cooperative and corelative indelible, detectable and undetectable verification data such as a session serial number (SSN), an individual user security badge (USB), a cumulative individual user rating score (URS), a frame serial number (FRSN), a facial serial number (FASN), and an audio serial number (ASN) that are all interdependent of each other, while it transcribes and stores audio files, video and photographic image files within a predetermined audio, video and photographic image frame, independent of the registered or unregistered camera recording speed, which may be directly correlated to the initial session serial number for viewing authentication. Unsolvable mathematical puzzles and QR codes may be used in place of or in addition to serial numbers.

Phase three, comprises constant monitoring of the recorded video feed and streaming transmission session to ensure the verified individual user (talent community) 21 is engaged in the system throughout the session. This consists of monitoring dynamic biometric markers to include but not limited to physiological and behavioral biometrics, facial, head or eyelid movement, pupillary dilation, or voiceprint, to maintain proof of life identification and liveness of the individual user during session use. The CM 23 of the COC 18 as shown in FIG. 2B directs the constant monitoring stream to the relevant DG 24.

The DGM 25 subjects individual users 21 to constant monitoring during a recorded video feed and streaming transmission session use to compare with the individual users' biometric markers on file. In the event monitored biometric markers continue to match and are maintained, the recorded video feed and streaming transmission session is determined to be a valid authentication and transmitted to the COC 18 as shown in FIG. 2B., embeds then superimposes a recognizable and standardized, indelible, detectible, hyperlinked appropriately color-coded security badge and an indelible, detectable, identity verification cumulative authentication rating score between 0%-100% validating user authentication for viewer notification. In the event the individual users monitored biometric markers are absent for a predetermined period of time or if the constantly monitored biometric markers change from that of the individual user during session processing, it is determined to be an invalid authentication and transmitted to the COC 18 as shown in FIG. 2B, embeds then superimposes a recognizable and standardized, indelible, detectible, hyperlinked appropriately colorcoded security badge and an indelible, detectable identity verification cumulative authentication rating score between 0%-100% invalidating user authentication throughout the processing of the recorded video feed and streaming transmission session for viewer notification.

During the constant monitoring process, the DGM 25 assigns and embeds through the CM 23 of the COC 18, a session serial number (SSN) that may be detectable or undetectable, into a predetermined recorded and transmitted video and or photographic image frame as the session begins. As a registered or unregistered computer device transmits a recorded audio video or photographic image of a specific human being, the DGM 25 assigns and embeds through the CM 23 of the COC 18 an indelible detectable or undetectable date/time stamp along with an encrypted indelible detectable or undetectable serial number, or an unsolvable mathematical puzzle and QR codes, to be used in place of or in addition to a serial number, in a predetermined video and or photographic image frame entitled a Session Serial Number, (SSN) indicating an authentically recorded video and or photographic image frame through the system.

As the recorded video feed and streaming transmission session continues, based on an individual user's successful or unsuccessful identity verification, an appropriately recognizable, standardized, indelible, detectible, hyperlinked color-coded security badge is assigned, embedded and superimposed on a predetermined video and photographic image frame by the DGM 25 that is hyperlinked to the COC 18. As a registered or unregistered camera records a specific human being, with identity being constantly monitored, the DGM 25 assigns and embeds, through the CM 23 of the COC 18, a standardized, indelible, detectible, superimposed, hyperlinked appropriately color-coded security badge in a predetermined frame entitled a User Security Badge (USB). In that particular frame, the identity verification of the specific human being indicates an authentically recorded video and or photographic image through the system of an individual user (talent community).

The next stage in the recorded video feed and streaming transmission session consist of the DGM 25 embedding an indelible detectable, superimposed cumulative authentication rating score ranging between 0% to 100%, indicating the degree of identity verification. As a registered or unregistered computer device transmits a recorded video of a specific human being, with identity being constantly monitored, the DGM 25 assigns and embeds through the CM 23 of the COC 18 an indelible, detectible superimposed, hyperlinked identity verification cumulative authentication rating score between 0% to 100% in a predetermined frame entitled a User Rating Score (URS) that is hyperlinked to the COC 18. In that particular frame, the identity verification of the specific human being is displayed to indicate the degree of recorded video and or photographic image authenticity through the system of an individual user (talent community).

The next stage in the recorded video feed and streaming transmission session consist of the DGM 25 assigning and embedding indelible detectable or undetectable serial numbers or unsolvable mathematical puzzles and QR codes to be used in place of or in addition to serial numbers, within a predetermined recorded frame. As a registered or unregistered computer device transmits a recorded video of a specific human being, with identity being constantly monitored, the DGM 25 assigns and embeds through the CM 23 of the COC 18 an indelible detectable or undetectable date/time stamp along with an encrypted indelible detectable or undetectable serial number, or unsolvable mathematical puzzles and QR codes to be used in place of or in addition to serial numbers, in a predetermined frame, entitled a Frame Serial Number (FRSN), within each predetermined frame, indicating the authentication of that particular frame and an authentically recorded video and or photographic image through the system of an individual user (talent community).

The next stage in the recorded video feed and streaming transmission session process consist of the DGM 25 assigning and embedding indelible detectable or undetectable serial numbers within the individual users face within a predetermined recorded frame. As a registered or unregistered computer device transmits a recorded video of a specific human being, with identity being constantly monitored, the DGM 25 assigns and embeds through the CM 23 of the COC 18 an indelible detectable or undetectable date/time stamp along with an encrypted indelible undetectable serial number, in a predetermined frame, entitled a Facial Serial Number (FASN), within each specific human beings face, in that particular frame, the authentication of the specific human being, indicating an authentically recorded video and or photographic image through the system of an individual user (talent community). Unsolvable mathematical puzzles and QR codes may be used in place of or in addition to serial numbers.

The next stage in the recorded video feed and streaming transmission session process consist of the DGM 25 assigning and embedding indelible detectable or undetectable serial numbers within an audio file within a predetermined frame. As a registered or unregistered computer device transmits a recorded video of a specific human being, the DGM 25 assigns and embeds through the CM 23 of the COC 18 an indelible detectable or undetectable date/time stamp along with an encrypted indelible undetectable serial number in a predetermined audio frame file entitled an Audio Serial Number (ASN), indicating authentically recorded audio through the system of an individual user (talent community). Unsolvable mathematical puzzles may be used in place of or in addition to serial numbers.

The next stage in the recorded video feed and streaming transmission session process consist of the DGM 25 recording, transcribing and storing all recorded audio files indelibly in the systems distributed DB's along with an encrypted indelible serial number entitled an Audio Serial Number (ASN) from predetermined audio frame files of a specific human being, enabling the verification and auditing of recorded audio files through the system for authenticity.

The final stage in the recorded video feed and streaming transmission session process consist of the DGM 25 recording and storing all transmitted video and photographic image files indelibly in the systems distributed DB's along with an encrypted indelible User Security Badge (USB), User Rating Score (URS), Frame Serial Number (FRSN) and Facial Serial Number (FASN) and or unsolvable mathematical puzzles and QR codes from predetermined video and photographic image frame files, enabling the verification and auditing of recorded video and photographic image files through the system for authenticity of an individual user (talent community).

FIG. 7 illustrates an exemplary embodiment of a method of commercial distribution of the present invention when utilized for a research, commercial and or government subscriber client. The embodiment of the present invention is designed to accommodate the differing distribution channel requirements of research, commercial and or government subscriber clients. The process begins with an individual user (uploads/views media) 21 logging in to a research, commercial and or government website and or app 27 of choice. Upon login, the selected research, commercial and or government website and or app 27 receives the recorded video feed and streaming transmission session via the individual user's (uploads/views media) wired and or wireless computing communication devices such as mobile phones, tablets, smart watches, gaming devices and any other Web network, or PC connected to the Internet utilizing microphones, thumbprint scanners, speakers and various style web cameras whereby the individual user's (talent community) 21 biometric markers contained within the recorded video feed and streaming transmission session and or recorded data, directed toward the systems COC 18 as shown in FIGS. 2A and 2B, are constantly monitored.

Upon constant monitoring of the individual user's (talent community) biometric markers contained within the recorded video feed and streaming transmission session data, the COC 18 as shown in FIGS. 2A and 2B the individual user's (talent community) identity is verified or unverified. Upon verification or unverification, the registered subscriber clients representative, as an individual user (uploads/views media) 28 within the COC 18 as shown in FIG. 2, acts as a portal to the subscriber clients research, commercial and or government website and or app 29. Throughout the system's recorded video feed and streaming transmission session process, the COC 18 as shown in FIGS. 2A and 2B constantly monitors the individual user's (talent community) biometric markers contained within the recorded video feed and streaming transmission session and or recorded data.

In the event monitored biometric markers of the individual user (talent community) continue to match and are maintained, the recorded video feed and streaming transmission session is determined to be a valid authentication and transmitted to the COC 18 as shown in FIGS. 2A and 2B, which embeds then superimposes a recognizable and standardized, indelible, detectible, hyperlinked appropriately color-coded security badge and an indelible, detectable identity verification cumulative authentication rating score between 0%-100% validating user authentication for viewer notification.

In the event constantly monitored biometric markers of the individual user (talent community) are absent for a predetermined period of time or if the monitored biometric markers change from that of the individual user (talent community) 21 during session processing, it is determined to be an invalid authentication and transmitted to the COC 18 as shown in FIGS. 2A and 2B, which embeds then superimposes a recognizable and standardized, indelible, detectible, hyperlinked appropriately color-coded security badge and an indelible, detectable identity verification cumulative authentication rating score between 0%-100% invalidating individual user (talent community) 21 authentication throughout the processing of the recorded video feed and streaming transmission session for viewer notification and informs the research, commercial and or government subscriber client and their representative of the detection.

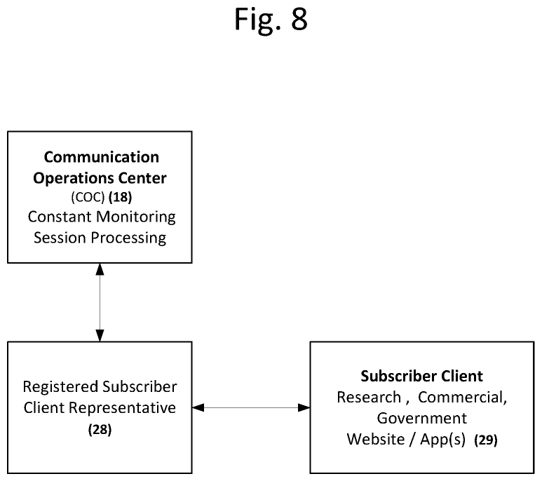

FIG. 8 illustrates the steps of an exemplary alternate method of distribution of the present invention when utilized by a particular research, commercial and or government subscriber client with the requirements of each research, commercial and or government subscriber client being unique. This embodiment is designed to accommodate the differing requirements of a research, commercial and or government subscriber client's distribution channels. The process begins when a subscriber client representative 28 who is an enabled individual user (uploads/views media) 21, with their constantly monitored biometric markers, logs into the systems COC 18 as shown in FIG. 2A. 2A and 2B where upon the subscriber client representative 28 is either verified or unverified. Upon verification, the subscriber client representative 28 is enabled within the systems COC 18 as shown in

FIGS. 2A and 2B to act as a portal to the research, commercial and or government website and or app 29 of choice, utilized by any other individual user (uploads/views media) 21. Throughout the recorded video feed and streaming transmission session, the system COC 18 as shown in FIGS. 2A and 2B constantly monitors the individual users' (talent community) 21 biometric markers and or recorded video feed and streaming transmission session and or recording data.

In the event monitored biometric markers of the individual user (talent community) continue to match and are maintained, the recorded video feed and streaming transmission session is determined to be a valid authentication and transmitted to the COC 18 as shown in FIGS. 2A and 2B, which embeds then superimposes a recognizable and standardized, indelible, detectible, hyperlinked appropriately color-coded security badge and an indelible, detectable identity verification cumulative authentication rating score between 0%-100% validating user authentication for viewer and registered subscriber client representative 28 notification.

In the event constantly monitored biometric markers of the individual user (talent community) 21 are absent for a predetermined period of time or if the monitored biometric markers change from that of the individual user (talent community) 21 during session processing, it is determined to be an invalid authentication and transmitted to the COC 18 as shown in FIGS. 2A and 2B, which embeds then superimposes a recognizable and standardized, indelible, detectible, hyperlinked appropriately color-coded security badge and an indelible, detectable identity verification cumulative authentication rating score between 0%-100% invalidating individual user (talent community) 21 authentication throughout the processing of the recorded video feed and streaming transmission session for viewer notification and informs the viewer, research, commercial and or government subscriber client representative of the detection.

### Operation

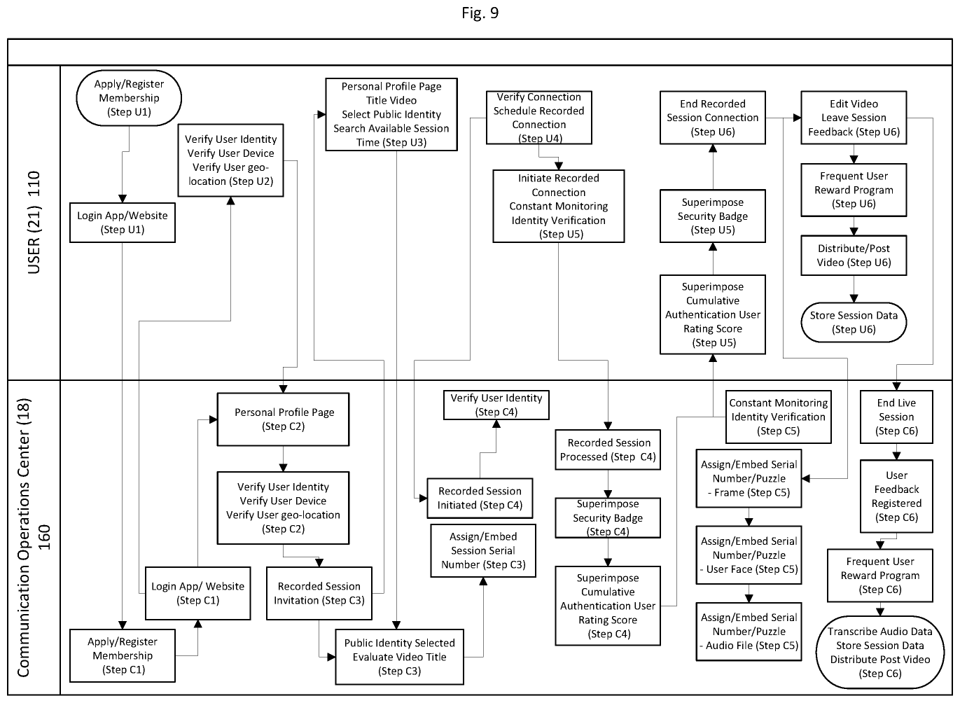

FIG. 9 is a sequence diagram that depicts successive steps between a user and the Communication Operations Center (COC) that are performed by different elements in FIG. 1 through FIG. 8, as it provides a uniform communication bidirectional layer for the systems recorded video feed and streaming transmission session.

In step U1, prospective user 21 begins the process by applying and registering for membership of the recorded video feed and streaming transmission system. Once the application and registration process has been successfully completed, user completes login to the systems website or app. In step U2, individual user (uploads/views media) 21 begins the identity verification process as shown in the systems COC 18 (FIG. 4). Once completed, individual user may verify and register the individual users' device and geo-location according to the embodiment of the invention. In step U3, individual user (uploads/views media) 21 enters their personal profile page to ensure personal biographic information is current. Individual user titles the pending recorded video feed and streaming transmission session to participate in the system. Individual user selects a public identity that may include their legal identity or an alias and or personalized avatar to maintain anonymity in the public forum. Finally, the individual user searches for an available recorded video feed and streaming transmission session date/time slot. In step U4, the individual user (uploads/views media) 21 verifies a connection then schedules a recorded video feed and streaming transmission session once a real-time push notification via an SMS message, email, or other message via another “external” notification channel is received by the individual user via the Cloud Server 150 having been transmitted by the Communication Operations Center 18 (FIG. 4) demonstrating a request to initiate a recorded video feed and streaming transmission session is acknowledged. For example, an SMS message, email, or other message via another “external” notification channel might include the following text, “You are invited to initiate your recorded video stream at the proposed time and date”. In step U5, the individual user (uploads/views media) 21 initiates the recorded video feed and streaming transmission session after the proposed scheduled recorded video feed and streaming transmission invitation is confirmed and authorized by the Communication Operations Center 18. In the event that a Communication Operations Center rejects the request from an individual user (uploads/views media) 21, the individual user (uploads/views media) 21 is notified and can restart the search process for an available date/time slot for a recorded video feed and streaming transmission session. Upon confirming the recorded video feed and streaming transmission session from the Communication Operations Center 18, and during the recorded video feed and streaming transmission session process, the individual user (talent community) 21 is constantly monitored to determine identity verification. An appropriately recognizable and standardized, indelible, detectible, hyperlinked color-coded security badge is embedded and superimposed on a predetermined video frame or photographic image based on their successful or unsuccessful identity verification to be embedded by the Communication Operations Center 18. Additionally, the Communication Operations Center 18 embeds and superimposes an indelible hyperlinked cumulative authentication rating score between 0% to 100% based on their successful or unsuccessful identity verification on a predetermined video frame or photographic image. In step U6, the individual user (uploads/views media) 21 may initiate or accept to end the recorded video feed and streaming transmission session with the Communication Operations Center 18. Once this task is completed, the individual user (uploads/views media) 21 may choose to edit the recorded video feed and streaming transmission session. Once this task is completed, the individual user (uploads/views media) 21 may choose to provide feedback and or rate the experience for the completed recorded video feed and streaming transmission session. At this stage, the individual user (uploads/views media) 21 may receive notification by the system of invention of a contribution being added to their frequent reward program in the form of commercial discounts, credits and or points, which is located in the individual user's 21 personal profile page. The individual user's (talent community) 21 recorded video feed and streaming transmission session data, biometric marker data and or personal biographic information may now be prepared for commercial distribution and or posted on subscriber client's 29 websites and or apps. Finally, all recorded video feed and streaming transmission session data may be stored for future commercial reference, disinterested third party authentication and or professional auditing. In step C1, the Communication Operations Center 18 begins the process by evaluating the membership application and registration submission of a prospective user 21 for the recorded video feed and streaming transmission system. Once the application and registration process has been successfully completed, the Communication Operations Center 18 acknowledges login to the systems website or app.

In step C2, the Communication Operations Center 18 evaluates the individual user's (uploads/views media and talent community) 21 personal profile page to ensure personal biographic information is current. The Communication Operations Center 18 begins the individual user 21 identity verification process as shown in the systems COC 18 (FIG. 4). Once completed, the Communication Operations Center verifies the individual users' device and geo-location.

In step C3, the Communication Operations Center 18 acknowledges a request, by the individual user (uploads/views media) 21 to schedule a recorded video feed and streaming transmission session to initiate a recorded video feed and streaming transmission session via the Cloud Server 150 received by the COC (18) 160 as shown in FIG. 1, via an SMS message, email, or other message via another “external” notification channel. For example, an SMS message might include the following text, “You are invited to initiate your recorded stream at the proposed time and date”. The Communication Operations Center 18 acknowledges a public identity that may include the individual user (uploads/views media) 21 legal identity or an alias and or an avatar to maintain anonymity in the public forum. The Communication Operations Center 18 then evaluates and acknowledges the recorded camera feed and streaming transmission session title. Finally, the Communication Operations Center (18) assigns an indelible Session Serial Number (SSN) to be embedded into a predetermined video and or photographic image frame. Unsolvable mathematical puzzles and QR codes may be used in place of or in addition to serial numbers.

In step C4, the Communication Operations Center (18) schedules and initiates a recorded video feed and streaming transmission session by notifying the individual user (uploads/views media) 21 via an SMS message, email, or other message via another “external” notification channel from the individual user 21 via the Cloud Server 150, agreeing to a request to initiate a recorded video feed and streaming transmission session. For example, an SMS message might include the following text, “Your recorded video stream at the proposed time and date is confirmed”. The Communication Operations Center 18 then verifies the identity of the individual user (uploads/views media and or talent community) 21 once the recorded video feed and streaming transmission session begins processing. The Communication Operations Center 18 then assigns, embeds and superimposes an appropriately recognizable and standardized, indelible, detectible, hyperlinked appropriately colorcoded security badge entitled User Security Badge (USB) based on the individual users successful or unsuccessful identity verification on to a predetermined frame of the recorded video feed and streaming transmission session. Finally, the Communication Operations Center 18 embeds and superimposes on a predetermined video and or photographic image frame, an indelible detectible hyperlinked identity verification cumulative authentication rating score between 0% to 100% to be viewed through subscriber client's 29 media hosting platforms.

In step C5, the Communication Operations Center 18 initiates the recorded video feed and streaming transmission upload after the proposed scheduled recorded video feed and streaming transmission connection is verified then initiated by the individual user (uploads/views media) 21 and confirmed by the Communication Operations Center 18. In the event that a Communication Operations Center 18 rejects the recorded video feed and streaming transmission from the individual user 21, the individual user 21 is notified. Upon initiating the recorded video feed and streaming transmission session and during the recorded video feed and streaming transmission session process, the Communication Operations Center 18 constantly monitors the individual user (talent community) 21 to determine identity verification. Based on the individual user (talent community) 21 identity verification, the Communication Operations Center 18 assigns and embeds an indelible, detectable or undetectable serial number entitled a Frame Serial Number (FRSN) on a predetermined video and or photographic image frame. Based on the individual user (talent community) 21 identity verification, the Communication Operations Center 18 assigns and embeds an indelible, detectable or undetectable serial number entitled a Facial Serial Number (FASN) on the recorded individual users (talent community) 21 face on a predetermined video and or photographic image frame. Based on the individual users (talent community) 21 identity verification, the Communication Operations Center assigns and embeds an indelible, detectable or undetectable serial number entitled an Audio Serial Number (ASN) on a predetermined audio file frame. Unsolvable mathematical puzzles and QR codes may be used in place of or in addition to serial numbers.

In step C6, the individual user (uploads/views media) 21 may initiate or accept to end the recorded video feed and streaming transmission session with the Communication Operations Center 18. Based on the experience for the completed session recording, the individual user (uploads/views media) 21 may submit feedback that can be registered by the Communication Operations Center 18 and contained within the individual users (uploads/views media) 21 personal profile page. At this stage, the individual user (uploads/views media) 21 may receive notification by the Communication Operations Center 18 of a contribution being added to their frequent user reward program in the form of commercial discounts, credits and or points, which is located in the individual user (uploads/views media) 21 personal profile page. The Communication Operations Center 18 transcribes the recorded audio data and makes it available to subscriber clients through the embedded and superimposed, recognizable and standardized, indelible, detectible, hyperlinked appropriately color-coded security badge entitled User Security Badge (USB) which may include the individual users (talent community) 21 biometric marker data and personal biographic information which is stored and may now be prepared for commercial distribution. Finally, all recorded video feed and streaming transmission data may be stored for future subscriber clients, commercial reference, disinterested third party authentication and or professional auditing.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A secure recorded camera feed and streaming transmission system with an online identity verification method and system to collect dynamic multimodal authentic biometric information of a specific human being for personal, research, commercial and government markets, utilizing a registered biometric detection and collection device by the individual in order to apply and register for access to the recorded video feed and streaming transmission system; the method comprising the steps of:
gathering, identifying, authenticating and registering individual biometric markers by incentivizing the applying individual user with greater security, open source architecture (OSArc), discarded personal data, participate in administering end user agreement, public anonymity and a reward program, by utilizing a registered biometric detection and collection device by the applying individual user; and
interfacing with a government agency to verify proof of life identification through a wired and or wireless computing communication device such as mobile phones, tablets, smart watches and any other Web network, or PC connected to the Internet utilizing microphones, thumbprint scanners, speakers and various style web cameras, a sufficient amount of said biometric markers correlated with uniquely pertinent personal biographic information collected directly from an applying individual user to authenticate the identity of the applying individual user gathered by the registered biometric detection and collection device interfacing through a registered or unregistered wired and or wireless computing communication device such as mobile phones, tablets, smart watches and any other Web network, or PC connected to the Internet utilizing microphones, thumbprint scanners, speakers and various style web cameras; and
upon said authentication, notifying the applying individual user of the affirmation that the applying individual user may register for access to the recorded video feed and streaming transmission system via electronic means and become a registered individual user, and upon denial of authentication, notifying the applying individual user of the rejection and that the applying individual user may reapply for access to the recorded video feed and streaming transmission system; and
constantly monitoring, tracking and analyzing the recorded video feed and streaming transmission for gathered biometric information of the now registered individual user (uploads/views media and talent community) correlated with uniquely pertinent personal biographic information, geo-location coordinates and recorded video feed and streaming transmission session data stored at a selected data bank in a biometric verification and data management system having a plurality of data banks at multiple levels of a database or decentralized blockchain, wherein said constant monitoring of recorded video feed and streaming transmission, tracking and analyzing steps include selecting the data bank based on the uniquely pertinent personal biographic information and geo-location coordinates gathered from the registered individual user (uploads/views media) to commercially utilize the recorded video feed and streaming transmission registered individual user (talent community) data via electronic means.

2. The method as recited in claim 1, wherein said biometric markers and uniquely pertinent personal biographic information is selected from a group consisting of individual user (uploads/views media and talent community) biometric markers includes gathering one or more or a plurality of such, as physiological and behavioral biometrics, an electronic facial image, voice print, thumbprint, etc., and may include but not be limited to the individual users' name, alias, birth date, city, state and or country of birth, physical description and characteristics, parents married and maiden name(s), current residential and employment address(s), current and past employer(s), preferred password, social security number, specific interests, academic achievement and other similar information, in order to apply for access to the system.

3. The method as recited in claim 2, wherein said step of: gathering individual user (uploads/views media and talent community) biometric markers includes gathering the individual user's categorical selection of personal interests to develop a unique profile for the applying individual user in the business to business (B2B), business to consumer (B2C) and consumer to consumer (C2C) within personal, research, commercial and government market models.

4. The method as recited in claim 2, wherein
said individual user (uploads/views media and talent community) biometric markers include an electronic image of an authentic, government issued form of identification selected from the group consisting of a driver's license, military, state or national identification card or passport, to be compared with the individual user's identification on file and on record with the issuing government agency via electronic means in order to apply for access to the recorded video feed and streaming transmission system and provide quality control authentication; and
when verified, notifying the individual user then providing a method for the verified individual user to register for a commercial coupon, consumer discount, and or frequent user loyalty/reward program in various markets.

5. The method as recited in claim 4, further comprising, the step of enabling the individual user (uploads/views media and talent community) to select the manner in which their government authenticated identity is to be publicly reflected by selecting public disclosure identification options from the group consisting of the individual user's government authenticated identification, an alias and or an avatar for selected apps and or websites including research institution websites, commercial websites, government websites, and social networks to maintain security to the recorded video feed and streaming transmission system.

6. The method as recited in claim 1, wherein said step of constantly monitoring individual user (uploads/views media and talent community) biometric markers comprises: uninterrupted evaluation of recorded streaming human interaction while logged on to the identity verification system for proof of liveness selected from the group consisting of facial, head or eyelid movement, pupillary or retinal dilation via video selfie, voice print and or finger print placement collected by said biometric detection and collection device.

7. The method as recited in claim 6, further comprising the step of: constantly monitoring the individual user's (uploads/views media) collected biometric markers and system usage in order to ensure that continued access to the secured recorded video feed and streaming transmission system remains authorized, and to time-out upon the absence of any of the biometric markers of the individual user when absent for a predetermined amount of time and block the individual user from continuous uninterrupted authorized access to either of registered computer systems or programs in the identity verification system.

8. The method as recited in claim 1, further comprising the step of:
storing the monitored, tracked, and analyzed unique and comprehensive profile of the individual user (uploads/views media and talent community) and recorded video feed and streaming transmission session data with the assignment of a uniform resource locator (URL) to be posted on video hosting platforms and providing editing tools for storage capability in a central repository and or decentralized blockchain and the recorded posting without editing, making it available to registered research institutions, commercial and or government entities via electronic means.

9. The method as recited in claim 8, wherein said step of making said stored unique and comprehensive profile of the individual user (uploads/views media and talent community) and recorded video feed and streaming transmission session data warehoused in a central repository and or decentralized blockchain available to research, commercial and or government entities, comprises:
requiring the registration and verification of the research, commercial and or government entity representative with the present identity verification system, and once registered and verified, allowing the research, commercial and or government entity representative access to the collected data of the individual user (talent community) including a unique and comprehensive profile of the individual user as one or a plurality of transactions including unique individual biometric markers or a comprehensive profile complete with cataloged, collated and analytical projections of a potential sequential course of the individual user to take in all individually unique physical and audio mannerisms within the system of invention; and
utilizing the registered and verified biometric detection and collection device selected from the group consisting of: a computer ready camera, a microphone, a bio-metric mouse and or touch pad for authenticating individual user (uploads/views media and talent community) identification to aid research, commercial and or government websites and banking institutions in identity theft detection endeavors, authenticating individual user (uploads/views media and talent community) identification to aid consumer security-background check companies in anti-identity theft endeavors; a registered computer ready camera, a microphone, a bio-metric mouse and or touch pad and an infrared scanner for authenticating individual user (uploads/views media and talent community) identification to aid employers in workplace enforcement for employees on-site, traveling, teleconferencing or telecommuting, and authenticating individual user (uploads/views media and talent community) identification to aid academic institutions in conducting roll-call or proctoring online testing; a registered computer ready camera, a microphone, a bio-metric mouse and or touch pad for authenticating individual user (uploads/views media and talent community) identification to aid in accessing or preventing access to building structures, to aid in accessing or preventing access to air transportation, to aid in accessing or preventing access to boat craft; a registered computer ready camera, a microphone, a bio-metric mouse and or touch pad for authenticating dynamic individual user (uploads/views media and talent community) identification to aid rating, polling, authentic marketing and research campaigns; a registered computer ready camera, a microphone, a bio-metric mouse and or touch pad for authenticating individual user (uploads/views media and talent community) identification to aid in regulatory/law enforcement, government programs, intelligence utilization and fraud detection; a registered computer ready camera, a microphone, a bio-metric mouse and or touch pad for authenticating individual user (uploads/views media and talent community) identification to aid in creating a biometric collage of current individual users (uploads/views media and talent community) to reflect and display a constantly evolving face, in mind reading video production and the detection of a specific human being versus a robot, human clone or artificial intelligence humanoid of a specific human being in video and photographic image production; a registered computer ready camera, a microphone, a bio-metric mouse and or touch pad for authenticating individual user (uploads/views media and talent community) identification to aid individual users and their legal representatives in reverse image search engines and for reverse voice recognition search engines for facial and voice recognition cease and desist endeavors; a registered computer ready camera, microphone, computer ready camera, a microphone, a bio-metric mouse and or touch pad for authenticating individual user (uploads/views media and talent community) identification to aid individual users and their legal representatives in licensing protected recorded video feed and streaming transmission media, enforcing residual and royalty agreements, synthetic video and photographic image detection by providing notarized and certified data sets for comparative models and notary publics to authenticate the execution of documents; a registered computer ready camera, a microphone, a bio-metric mouse and or touch pad; and providing compensation, monetary credit, a donation credit or an incentive to an online banking repository or commercial institution, a donation credit or incentive to a non-profit organization, or an amount or value incentive of a frequent user reward program for the individual user (uploads/views media and talent community) to redeem; and providing at least one of a corresponding electronic/digital graphs, charts, logs, tables, records or meters to plot the identity verification system's use for individual users (uploads/views media and talent community) and registered research, commercial and or government entities for business to business (B2B), business to consumer (B2C) and consumer to consumer
(C2C) commercial markets within the recorded video feed and streaming transmission system.

10. A computer implemented recorded video feed and streaming transmission system for harvesting biometric information of an individual user (uploads/views media and talent community) for personal, research, commercial and or government distribution, the system comprising:
a server coupled with a computer processor having memory storage and computer executable software programs stored therein;
a biometric detection and collection device connected in communication with said processor and operative upon instructions from said computer program instructions to gather dynamic biometric information and recorded video feed and streaming transmission session data from the individual user
(uploads/views media and talent community);
a registered biometric detection and collection device interfaced in communication with wired and or wireless computing communication devices such as mobile phones, tablets, smart watches and any other Web network, or PC connected to the Internet utilizing microphones, thumbprint scanners, speakers and various style web cameras and interfaced in communication with a government agency for identification authentication;
upon execution of software program instructions by said computer processor, said biometric detection and collection device and said wired and or wireless computing communication device such as mobile phones, tablets, smart watches and any other Web network, or PC connected to the Internet utilizing microphones, thumbprint scanners, speakers and various style web cameras are caused to gather biometric markers and uniquely personal biographic information directly from an individual user (uploads/views media and talent community) to authenticate the identity, proof of life identification and liveness of the individual user (uploads/views media and talent community), and the geo-location to identify the latitude and longitude to specifically locate the individual user (uploads/views media); and
a communication operations center configured to receive session verification requests of the gathered biometric markers, uniquely personal biographic information, and geo-location coordinates and direct them to a selected data group in a biometric verification and data management system having a plurality of data banks at multiple levels of a database, and having a data group manager program configured to select the database and or decentralized blockchain based on the uniquely personal biographic information and geo-location coordinates gathered from the individual user (uploads/views media).

11. The system as recited in claim 10, wherein said biometric detection and collection device is configured to gather through said interfacing registered or unregistered wired and or wireless computing communication device such as mobile phones, tablets, smart watches and any other Web network, or PC connected to the Internet utilizing microphones, thumbprint scanners, speakers and various style web cameras, biometric markers, uniquely personal biographic information, geo-location coordinates, and unique identifiers directly from an individual user (uploads/views media and talent community), selected from a group consisting of their name, alias, birth date, city/state and/or country of birth, physical description and characteristics, parents married and maiden name(s), current address(s), current and past employer(s), preferred password, social security number, specific interests, and other similar information, categorical selection of interests and related information.

12. The system as recited in claim 11, wherein said biometric detection and collection device is configured to gather biometric information from the individual user (uploads/views media and talent community) through said interfaced registered or unregistered wired and or wireless computing communication device such as mobile phones, tablets, smart watches and any other Web network, or PC connected to the Internet utilizing microphones, thumbprint scanners, speakers and various style web cameras and is electronically interfaced in communication with a government agency to authenticate identification with biometric markers and uniquely pertinent personal biographic information of said individual user through said system server.

13. The system as recited in claim 11, wherein said communication operations center includes a communication manager processor configured to analyze the biometric markers, uniquely pertinent personal biographic information, and geo-location coordinates to identify patterns for developing a unique profile; and a data group processor interfaced with said communication manager processor configured to select a database and or decentralized blockchain corresponding to said identified patterns.

14. The system as recited in claim 13, wherein said communication manager processor is further configured to analyze the biometric markers, uniquely pertinent personal biographic information, and geo-location coordinates to authenticate the individual user's (uploads/views media and talent community) proof of life identification with a government agency, and to select a database and or decentralized blockchain based on the identified patterns of biometric markers correlated with uniquely pertinent personal biographic information and geo-location coordinates.

15. The system as recited in claim 14, wherein said communication manager processor is further configured to select a local database at a local level of the database and or decentralized blockchain when the biometric markers, uniquely pertinent personal biographic information, and geo-location coordinates gathered from the individual user (uploads/views media and talent community) indicates that the individual user may be located in an associated local area for more than a threshold period of time and for less than the threshold period of time.

16. The system as recited in claim 11, wherein said registered biometric detection and collection device includes at least one of: a camera, a microphone, a biometric computer mouse, a touch pad, a thermometer, a pulse detector and a respiration detector.

17. The system as recited in claim 11, wherein said biometric detection and collection device is interfaced with a registered or unregistered wired and or wireless computing communication device such as mobile phones, tablets, smart watches and any other Web network, or PC connected to the Internet utilizing microphones, thumbprint scanners, speakers and various style web cameras that transmits the gathered biometric markers, uniquely pertinent personal biographic information and geo-location coordinates over a wired or wired and or wireless connection to a central repository and or decentralized blockchain for facilitation of identification verification;
said central repository and or decentralized blockchain facilitates identification verification in conjunction with a communication manager processor and an archive manager processor within a communication operations center, said communication manager processor is configured to receive at login, a session verification request of the gathered biometric markers, uniquely pertinent personal biographic information, and geo-location coordinates to direct the biometric markers, uniquely pertinent personal biographic information, geo-location coordinates and recorded video feed and streaming transmission session data to a selected data group where the individual user (uploads/views media and talent community) data is stored to be processed and either verified or unverified by the data group manager which automatically returns the response to the individual user waiting for verification in the form of a standardized, indelible, detectible, superimposed, hyperlinked, appropriately color-coded security badge to verify media data authenticity (transcribed audio files, date/time, identity verification, etc.) through the system servers and an indelible, detectable, superimposed identity verification cumulative authentication rating score between 0%-100%;
said archive manager processor monitors all the data group data for damage, data integrity, usage, scheduling of regular backups, initiates emergency backups as needed and is responsible for data backups to hard, secure off-site locations, as well as any needed restorations; and
said communication manager processor is configured to randomly store the gathered biometric markers, uniquely pertinent personal biographic information and geo-location coordinates separately to the selected data group manager processor then randomly send a separate copy of the biometric markers, uniquely pertinent personal biographic information and geo-location coordinates to the selected database which are location independent and or decentralized blockchain when all system components are networked using an ultra-high-speed network;
said data group manager serves as the database controller and processing center that receives a session verification request from the communication manager processor, then accesses the database where the individual user's biometric data is stored and evaluates the session verification request to determine if the individual user matches the gathered biometric data, the data group manager monitors the time used for each individual user session verification request and if, due to traffic density, this response time exceeds a maximum response time threshold, will automatically route session verification requests to as many mirror sites as necessary to remain within the required response time;
said database is a computer server that stores the individual user's biometric data and evaluates the session verification request to determine if the individual user matches the individual user that the biometric data belongs to where a session verification request is received from the communication manager, the data group manager will access the database and or decentralized blockchain; and
data group mirror sites are used to maintain processing speed and response time during periods of high demand.

18. The system as recited in claim 17, wherein said archive manager processor monitors all the data group data for damage, data integrity, usage, scheduling of regular backups, initiates emergency backups as needed and is responsible for data backups to hard, secure off-site locations, as well as any needed restorations; and
said communication manager processor is configured to embed cooperative and correlative indelible, encrypted, undetectable session serial numbers, facial serial numbers, voice print (audio file) serial numbers and video frame serial numbers or unsolvable mathematical puzzles and QR codes in place of or in addition to serial numbers within predetermined video and photographic image frames then randomly store the recorded video feed and streaming transmission data.

19. The system as recited in claim 11, further comprising;
a registered or unregistered wired and or wireless computing communication device such as mobile phones, tablets, smart watches and any other Web network, or PC connected to the Internet utilizing microphones, thumbprint scanners, speakers and various style web cameras configured to receive through an input mechanism, the unique identification number of an unverified individual user (uploads/views media and talent community);
gather through a biometric detection and collection device, new biometric markers, including physiological and behavioral biometrics, a video selfie to demonstrate “liveness” with facial, head or eyelid movement, pupillary dilation, uniquely pertinent personal biographic information and geolocation coordinates from the unverified individual user; and
transmit the unique identification number and new biometric markers, uniquely pertinent personal biographic information and geo-location coordinates, interfacing with a registered or unregistered wired and or wireless computing communication device such as mobile phones, tablets, smart watches and any other Web network, or PC connected to the Internet utilizing microphones, thumbprint scanners, speakers and various style web cameras over a wired or wired and or wireless connection to a communication manager processor with a session verification request to authenticate the identity of the unverified individual user with a government agency; and
to receive a positive or negative verification response from the government agency to authenticate proof of life identification or reject authenticity of the proof of life identification.

20. The system as recited in claim 19, wherein said authentication of the identity of an unverified individual user with a government agency to verify proof of life identification is to be conducted by the individual user to decode with, by, but not limited to a PDF417 two-dimensional high-density stacked linear barcode, capable of encoding text, files and data bytes, or similar, such as Optical Character Recognition, Ultra Violet Lighting and Hologram detection that may contain biometric data and pertinent personal biographic information that is often included on a current government issued driver's license, military, state or national ID or passport, communicating via computer interface with the corresponding state or federal government agency that is responsible for authentication of government issued forms of identification.
